(19) United States
(12) Patent Application Publication
(10) Pub. No.: US 2017/0235390 A1
(43) Pub. Date: Aug. 17, 2017

(54) TOUCH CONTROL DISPLAY PANEL, DISPLAY DEVICE HAVING THE SAME, AND FABRICATING METHOD THEREOF

(71) Applicants: BOE TECHNOLOGY GROUP CO., LTD., Beijing (CN); Chengdu BOE Optoelectronics Technology Co., Ltd., Chengdu (CN)

(72) Inventors: Xiangdan Dong, Beijing (CN); Youngyik Ko, Beijing (CN); Lei Dai, Beijing (CN)

(73) Assignees: BOE TECHNOLOGY GROUP CO., LTD., Beijing (CN); Chengdu BOE Optoelectronics Technology Co., Ltd., Chengdu (CN)

(21) Appl. No.: 15/302,882

(22) PCT Filed: Apr. 6, 2016
(86) PCT No.: PCT/CN2016/078553

§ 371 Date: Oct. 7, 2016

(30) Foreign Application Priority Data
Jun. 25, 2015 (CN) 201510359091.2

(51) Int. Cl. G06F 3/044

(52) U.S. Cl. CPC G06F 3/044; G06F 2203/04111; G06F 2203/04103

(57) ABSTRACT

The present application discloses a touch control display panel comprising a base substrate; a first touch electrode layer comprising a plurality of first touch electrodes; a second touch electrode layer comprising a plurality of second touch electrodes; a plurality of connection islands; a plurality of first bridges; a plurality of second bridges; and a plurality of third bridges. The plurality of first electrodes are spaced apart along a first direction; the plurality of second electrodes are spaced apart along a second direction; the second direction intersecting the first direction forming a plurality of intersections; a connection island is at each intersection surrounded by and insulated from two adjacent first touch electrodes along the first direction and two adjacent second touch electrodes along the second direction. The connection island at each intersection is electrically connected to one of the two adjacent first touch electrodes through a first bridge and electrically connected to another of the two adjacent first touch electrodes through a second bridge. The two adjacent second touch electrodes are electrically connected at each intersection through a third bridge, the third bridge insulated from the connection island at each intersection.

### CROSS-REFERENCE TO RELATED APPLICATION

This application claims priority to Chinese Patent Application No. 201510359091.2, filed Jun. 25, 2015, the contents of which are incorporated by reference in the entirety.

### TECHNICAL FIELD

The present invention relates to display technology, more particularly, to a touch control display panel, a display device having the same, and a fabricating method thereof.

### BACKGROUND

A conventional touch control display panel includes a plurality of first touch electrodes arranged in columns and a plurality of second touch electrode in rows intersecting the columns. Two adjacent first touch electrodes along a column are connected through a first connection pattern. Two adjacent second touch electrodes along a row are connected through a second connection pattern.

### SUMMARY

In one aspect, the present invention provides a touch control display panel comprising a base substrate; a first touch electrode layer comprising a plurality of first touch electrodes; a second touch electrode layer comprising a plurality of second touch electrodes; a plurality of connection islands; a plurality of first bridges; a plurality of second bridges; and a plurality of third bridges. The plurality of first electrodes are spaced apart along a first direction; the plurality of second electrodes are spaced apart along a second direction; the second direction intersecting the first direction forming a plurality of intersections; a connection island is at each intersection surrounded by and insulated from two adjacent first touch electrodes along the first direction and two adjacent second touch electrodes along the second direction. The connection island at each intersection is electrically connected to one of the two adjacent first touch electrodes through a first bridge and electrically connected to another of the two adjacent first touch electrodes through a second bridge. The two adjacent second touch electrodes are electrically connected at each intersection through a third bridge, the third bridge insulated from the connection island at each intersection.

Optionally, the plurality of connection islands are in a same layer as the first touch electrode layer.

Optionally, the first touch electrode layer is in a same layer as the second touch electrode layer.

Optionally, the plurality of first bridges, the plurality of second bridges and the plurality of third bridges are in a same layer.

Optionally, the first direction and the second direction are substantially perpendicular to each other.

Optionally, any of the first bridge, the second bridge and the third bridge has a higher electrical conductivity than the first touch electrode and the second touch electrode.

Optionally, the touch control display panel further comprises an insulating layer insulating the plurality of first bridges and the plurality of second bridges from the plurality of connection islands, the insulating layer comprises a plurality of vias through which the first bridge and the second bridge at each intersection are electrically connected to the connection island and the two adjacent first touch electrodes.

Optionally, the touch control display panel further comprises an insulating layer insulating the plurality of third bridges from the plurality of connection islands, the insulating layer comprises a plurality of vias through which the third bridge at each intersection are electrically connected to the two adjacent second touch electrodes.

Optionally, the touch control display panel further comprises an insulating layer insulating the plurality of first bridges, the plurality of second bridges and the plurality of third bridges from the plurality of connection islands, the insulating layer comprises a plurality of vias through which the first bridge and the second bridge at each intersection are electrically connected to the connection island and the two adjacent first touch electrodes, and the third bridge at each intersection are electrically connected to the two adjacent second touch electrodes.

Optionally, the first bridge, the second bridge and the third bridge are on a side of the connection island proximal to the base substrate.

Optionally, the first bridge, the second bridge and the third bridge are on a side of the connection island distal to the base substrate.

Optionally, a width of the connection island along the second direction in a portion corresponding to the third bridge is less than a maximum width of the connection island along the second direction.

Optionally, at least one pair of two adjacent second touch electrodes are electrically connected at each intersection through only one third bridge.

Optionally, at least one pair of two adjacent second touch electrodes are electrically connected at each intersection through two third bridges, projections of which on the connection island are proximal to two terminus of the connection island along the first direction.

Optionally, the first bridge extends along a direction at an acute angle relative to the first direction, and the second bridge extends along a direction at an acute angle relative to the first direction.

Optionally, the third bridge comprises a first segment and a second segment adjoining each other, the first segment extends along a direction at an acute angle relative to the first direction, and the second segment extends along a direction at an acute angle relative to the first direction.

Optionally, at least one of the first bridge, the second bridge and the third bridge is made of a metal.

In another aspect, the present invention provides a method of fabricating a touch control display panel comprising forming a first touch electrode layer comprising a plurality of first touch electrodes; forming a second touch electrode layer comprising a plurality of second touch electrodes; forming a plurality of connection islands; forming a plurality of first bridges; forming a plurality of second bridges; and forming a plurality of third bridges. The plurality of first electrodes are spaced apart along a first direction; the plurality of second electrodes are spaced apart along a second direction; the second direction intersecting the first direction forming a plurality of intersections; a connection island is at each intersection surrounded by and insulated from two adjacent first touch electrodes along the first direction and two adjacent second touch electrodes along the second direction. The connection island at each intersection is electrically connected to one of the two adjacent first touch electrodes through a first bridge and electrically connected to another of the two adjacent first touch electrodes through a second bridge. The two adjacent second touch electrodes are electrically connected at each intersection through a third bridge, the third bridge insulated from the connection island at each intersection.

Optionally, the method further comprises forming an insulating layer; wherein the insulating layer insulates one or more of the plurality of first bridges, the plurality of second bridges, and the plurality of third bridges from the plurality of connection islands; and forming a plurality of vias through which the first bridge and the second bridge at each intersection are electrically connected to the connection island and the two adjacent first touch electrodes, and the third bridge at each intersection are electrically connected to the two adjacent second touch electrodes.

Optionally, the method further comprises forming a metal layer on a base substrate; patterning the metal layer to form the plurality of first bridges, the plurality of second bridges, and the plurality of third bridges; forming the insulating layer on a side of the plurality of first bridges, the plurality of second bridges, and the plurality of third bridges distal to the base substrate; forming the plurality of vias in the insulating layer; forming a transparent conductive layer on a side of the insulating layer distal to the base substrate; and patterning the transparent conductive layer to form the plurality of connection islands, the plurality of first touch electrodes, and the plurality of second touch electrodes.

Optionally, the method further comprises forming a transparent conductive layer on a base substrate; patterning the transparent conductive layer to form the plurality of connection islands, the plurality of first touch electrodes, and the plurality of second touch electrodes; forming the insulating layer on a side of the plurality of connection islands, the plurality of first touch electrodes, and the plurality of second touch electrodes distal to the base substrate; forming the plurality of vias in the insulating layer; forming a metal layer on a side of the insulating layer distal to the base substrate; and patterning the metal layer to form the plurality of first bridges, the plurality of second bridges, and the plurality of third bridges.

In another aspect, the present invention provides a display device comprising a touch control display panel described herein or fabricated by a method described herein.

### BRIEF DESCRIPTION OF THE FIGS

The following drawings are merely examples for illustrative purposes according to various disclosed embodiments and are not intended to limit the scope of the present invention.

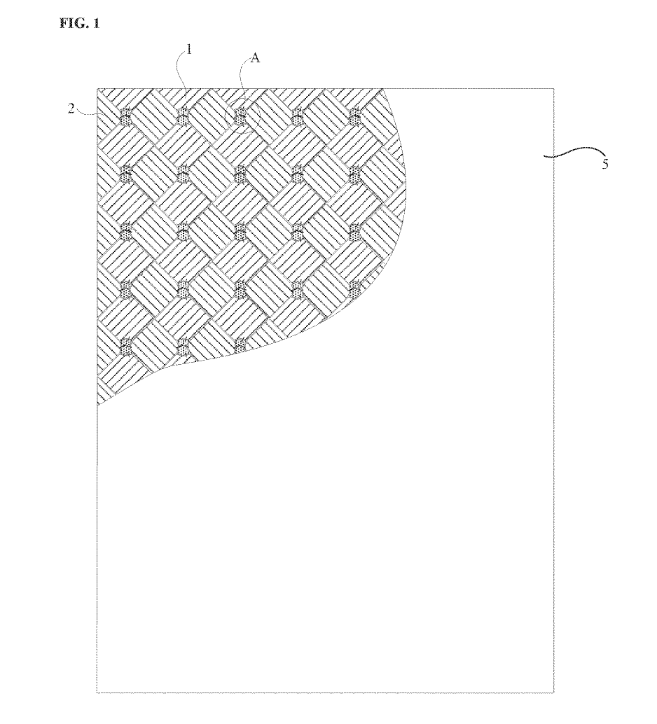

FIG. 1 is a diagram illustrating the structure of a touch control display panel in some embodiments.

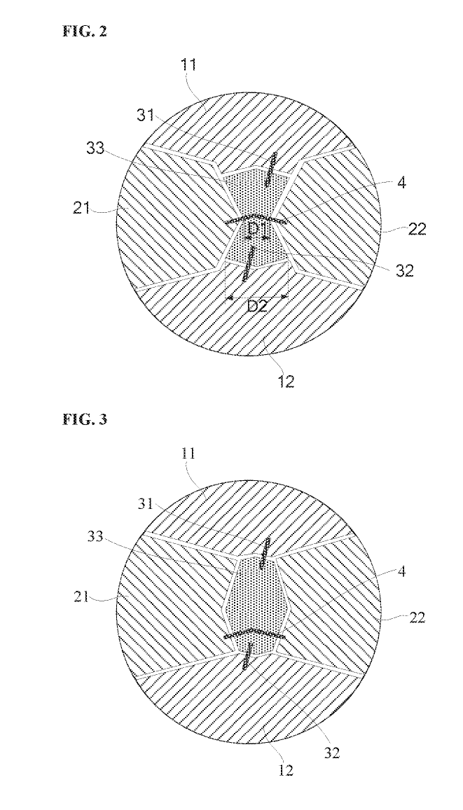

FIG. 2 is a close up view of the section A in FIG. 1.

FIG. 3 is a diagram illustrating the structure of an intersection between a first direction and a second direction.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

In conventional touch control display panels, the overlaps between the first touch electrodes/connection pattern and the second touch electrodes/connection pattern result in parasitic capacitance. Typically, to reduce parasitic capacitance in conventional touch control display panels, adjacent first touch electrodes along a first direction are connected through a connection pad integrally formed with the plurality of first touch electrodes, and adjacent second touch electrodes along a second direction are connected through a bridge. This design results in a higher resistance in the first touch electrodes along the first direction as compared to the second touch electrodes along the second direction, adversely affecting touch control performance.

The present disclosure provides a superior touch control display panel that overcomes the disadvantages of conventional touch control display panels. In some embodiments, the touch control display panel includes a base substrate, a first touch electrode layer comprising a plurality of first touch electrodes; a second touch electrode layer comprising a plurality of second touch electrodes; a plurality of connection islands; a plurality of first bridges; a plurality of second bridges; and a plurality of third bridges. The plurality of first electrodes are spaced apart along a first direction; the plurality of second electrodes are spaced apart along a second direction. The second direction intersecting the first direction forming a plurality of intersections. A connection island is at each intersection, and is surrounded by, but spaced apart and insulated from two adjacent first touch electrodes along the first direction and two adjacent second touch electrodes along the second direction. Optionally, the first direction and the second direction are substantially perpendicular to each other, e.g., one is a column direction and the other is a row direction.

The connection island is made of a conductive material. At each intersection, the connection island is electrically connected to one of the two adjacent first touch electrodes through a first bridge and electrically connected to another of the two adjacent first touch electrodes through a second bridge. The two adjacent second touch electrodes at each intersection are electrically connected through a third bridge. The third bridge is insulated from the connection island at each intersection. Optionally, at least one of the first bridge, the second bridge and the third bridge is made of a metal. Optionally, any of the first bridge, the second bridge and the third bridge has a higher electrical conductivity than the first touch electrode and the second touch electrode.

In some embodiments, the plurality of connection islands are in a same layer as the first touch electrode layer. Optionally, the first touch electrode layer is in a same layer as the second touch electrode layer. Optionally, the first touch electrode layer, the second touch electrode layer, and the plurality of connection islands are in a same layer. Optionally, the plurality of first bridges and the plurality of second bridges are in a same layer. Optionally, the plurality of first bridges, the plurality of second bridges and the plurality of third bridges are in a same layer. Optionally, the plurality of first bridges, the plurality of second bridges and the plurality of third bridges are on a same side of the connection island (or the first/second touch electrode layer). Optionally, the plurality of first bridges, the plurality of second bridges and the plurality of third bridges are on a side of the connection island (or the first/second touch electrode layer) proximal to the base substrate. Optionally, the plurality of first bridges, the plurality of second bridges and the plurality of third bridges are on a side of the connection island (or the first/second touch electrode layer) distal to the base substrate. Optionally, the plurality of first bridges and the plurality of second bridges are on a different side of the connection island (or the first/second touch electrode layer) from the plurality of third bridges. Optionally, the plurality of first bridges and the plurality of second bridges are on a side of the connection island (or the first/second touch electrode layer) proximal to the base substrate and the plurality of third bridges are on a side of the connection island (or the first/second touch electrode layer) distal to the base substrate. Optionally, the plurality of first bridges and the plurality of second bridges are on a side of the connection island (or the first/second touch electrode layer) distal to the base substrate and the plurality of third bridges are on a side of the connection island (or the first/second touch electrode layer) proximal to the base substrate.

In some embodiments, a width of the connection island along the second direction in a portion corresponding to the third bridge is less than a maximum width of the connection island along the second direction. For example, the connection island may have two opposite concave surfaces, each of which facing an adjacent second touch electrode along the second direction; and the third bridge crosses the middle portion of the two concave surfaces, connecting two adjacent touch electrodes. In some display panels, the connection island has two opposite convex surfaces, each of which facing an adjacent second touch electrode along the second direction; and one or more third bridges crosses the upper portion and/or the lower portion of the two convex surfaces, connecting two adjacent touch electrodes.

The connection island at each intersection may be electrically connected to one of the two adjacent first touch electrodes through one or more (e.g., two) first bridges. The connection island at each intersection may be electrically connected to another of the two adjacent first touch electrodes through one or more (e.g., two) second bridges. The two adjacent second touch electrodes may be electrically connected at each intersection through one or more (e.g., two) third bridges. In some embodiments, at least one pair of two adjacent second touch electrodes are electrically connected at each intersection through only a third bridge. In some embodiments, at least one pair of two adjacent second touch electrodes are electrically connected at each intersection through two third bridges. Optionally, projections of the two third bridges on the connection island are proximal to two terminus of the connection island along the first direction, i.e., one third bridge crosses the upper portion of the connection island and the other third bridge crosses the lower portion of the connection island.

The first bridge extends along a direction at an angle a relative to the first direction. The second bridge extends along a direction at an angle β relative to the first direction. The third bridge extends along a direction at an angle γ relative to the first direction. Angles α, β, and γ may be the same. In some embodiments, any of the first bridge, the second bridge, and the third bridge (e.g., the third bridge) includes a first segment and a second segment adjoining each other, the first segment extends along a direction at an angle θ1 relative to the first direction, and the second segment extends along a direction at an angle θ2 relative to the first direction. Optionally, angles α, β, γ, θ1, and θ2 are acute angles (i.e., between 0° and 90°). Optionally, angles α, β, γ, θ1, and θ2 are in the range of 5° to 95°, e.g. between 5° and 45°, between 45° and 95°, between 10 and 80°, between 20° and 70°, between 30° and 60°, between 40° and 50°, between 5° and 25°, between 25° and 45°, between 45° and 65°, or between 65° and 85°. Optionally, one or more of angles α, β, γ, θ1, and θ2 is 0°.

In some embodiments, the touch control display panel further includes an insulating layer insulating one or more of the plurality of first bridges, the plurality of second bridges, and the plurality of third bridges from the plurality of connection islands and/or the plurality of first/second touch electrodes. Optionally, the touch control display panel includes two insulating layers, e.g., one insulating layer insulates the plurality of first bridges and the plurality of second bridges from the plurality of connection islands, and another insulates the plurality of third bridges from the plurality of connection islands. Optionally, the insulating layer insulates the plurality of first bridges and the plurality of second bridges from the plurality of connection islands (and the plurality of first/second touch electrodes), and the insulating layer includes a plurality of vias through which the first bridge and the second bridge at each intersection are electrically connected to the connection island and the two adjacent first touch electrodes. Optionally, the insulating layer insulates the plurality of third bridges from the plurality of connection islands (and the plurality of first/second touch electrodes), and the insulating layer includes a plurality of vias through which the third bridge at each intersection are electrically connected to the two adjacent second touch electrodes. Optionally, the insulating layer insulates the plurality of first bridges, the plurality of second bridges and the plurality of third bridges from the plurality of connection islands (and the plurality of first/second touch electrodes), and the insulating layer includes a plurality of vias through which the first bridge and the second bridge at each intersection are electrically connected to the connection island and the two adjacent first touch electrodes, and the third bridge at each intersection are electrically connected to the two adjacent second touch electrodes.

In another aspect, the present disclosure provides a method of fabricating a touch control display panel. In some embodiments, the method includes forming a first touch electrode layer including a plurality of first touch electrodes; forming a second touch electrode layer including a plurality of second touch electrodes; forming a plurality of connection islands; forming a plurality of first bridges; forming a plurality of second bridges; and forming a plurality of third bridges. The plurality of first electrodes are spaced apart along a first direction; the plurality of second electrodes are spaced apart along a second direction. The second direction intersecting the first direction forming a plurality of intersections. A connection island is at each intersection, and is surrounded by, but spaced apart and insulated from two adjacent first touch electrodes along the first direction and two adjacent second touch electrodes along the second direction. Optionally, the first direction and the second direction are substantially perpendicular to each other, e.g., one is a column direction and the other is a row direction.

The connection island is made of a conductive material. At each intersection, the connection island is electrically connected to one of the two adjacent first touch electrodes through a first bridge and electrically connected to another of the two adjacent first touch electrodes through a second bridge. The two adjacent second touch electrodes at each intersection are electrically connected through a third bridge. The third bridge is insulated from the connection island at each intersection. Optionally, at least one of the first bridge, the second bridge and the third bridge is made of a metal. Optionally, any of the first bridge, the second bridge and the third bridge has a higher electrical conductivity than the first touch electrode and the second touch electrode.

In some embodiments, the plurality of connection islands are formed in a single process and in a same layer as the first touch electrode layer. Optionally, the first touch electrode layer is formed in a single process and in a same layer as the second touch electrode layer. Optionally, the first touch electrode layer, the second touch electrode layer, and the plurality of connection islands are formed in a single process and in a same layer. Optionally, the plurality of first bridges and the plurality of second bridges are formed in a single process and in a same layer. Optionally, the plurality of first bridges, the plurality of second bridges and the plurality of third bridges are formed in a single process and in a same layer. Optionally, the plurality of first bridges, the plurality of second bridges and the plurality of third bridges are formed on a same side of the connection island (or the first/second touch electrode layer). Optionally, the plurality of first bridges, the plurality of second bridges and the plurality of third bridges are formed on a side of the connection island (or the first/second touch electrode layer) proximal to the base substrate. Optionally, the plurality of first bridges, the plurality of second bridges and the plurality of third bridges are formed on a side of the connection island (or the first/second touch electrode layer) distal to the base substrate. Optionally, the plurality of first bridges and the plurality of second bridges are formed on a different side of the connection island (or the first/second touch electrode layer) from the plurality of third bridges. Optionally, the plurality of first bridges and the plurality of second bridges are formed on a side of the connection island (or the first/second touch electrode layer) proximal to the base substrate and the plurality of third bridges are on a side of the connection island (or the first/second touch electrode layer) distal to the base substrate. Optionally, the plurality of first bridges and the plurality of second bridges are formed on a side of the connection island (or the first/second touch electrode layer) distal to the base substrate and the plurality of third bridges are on a side of the connection island (or the first/second touch electrode layer) proximal to the base substrate.

In some embodiments, the method further includes forming an insulating layer and forming a plurality of vias through which the first bridge and the second bridge at each intersection are electrically connected to the connection island and the two adjacent first touch electrodes, and the third bridge at each intersection are electrically connected to the two adjacent second touch electrodes. The insulating layer insulates one or more of the plurality of first bridges, the plurality of second bridges, and the plurality of third bridges from the plurality of connection islands.

In some embodiments, the method includes forming a metal layer on the base substrate; patterning the metal layer to form the plurality of first bridges, the plurality of second bridges, and the plurality of third bridges; forming the insulating layer on a side of the plurality of first bridges, the plurality of second bridges, and the plurality of third bridges distal to the base substrate; forming the plurality of vias in the insulating layer; forming a transparent conductive layer on a side of the insulating layer distal to the base substrate; and patterning the transparent conductive layer to form the plurality of connection islands, the plurality of first touch electrodes, and the plurality of second touch electrodes.

In some embodiments, the method includes forming a transparent conductive layer on the base substrate; patterning the transparent conductive layer to form the plurality of connection islands, the plurality of first touch electrodes, and the plurality of second touch electrodes; forming the insulating layer on a side of the plurality of connection islands, the plurality of first touch electrodes, and the plurality of second touch electrodes distal to the base substrate; forming the plurality of vias in the insulating layer; forming a metal layer on a side of the insulating layer distal to the base substrate; and patterning the metal layer to form the plurality of first bridges, the plurality of second bridges, and the plurality of third bridges.

FIG. 1 is a diagram illustrating the structure of a touch control display panel in some embodiments. FIG. 2 is a close up view of the section A in FIG. 1. Referring to FIG. 1 and FIG. 2, the touch control display panel in the embodiment includes a base substrate 5, a first touch electrode layer comprising a plurality of first touch electrodes 1, and a second touch electrode layer comprising a plurality of second touch electrodes 2. The plurality of first electrodes 1 and the plurality of second electrodes 2 are in a same layer. The plurality of first electrodes 1 are spaced apart along a first direction. The plurality of second electrodes 2 are spaced apart along a second direction. The first direction and the second direction are substantially perpendicular to each other. The second direction intersects the first direction forming a plurality of intersections. Adjacent first touch electrodes 11 and 12 along the first direction are electrically connected by a first connection pattern at each intersection. Adjacent second touch electrodes 21 and 22 along the second direction are electrically connected by a second connection pattern at each intersection.

As shown in FIG. 2, the first connection pattern includes a connection island 33, at least one first bridge 31 and at least one second bridge 32. The connection island 33 is in a same layer as the first touch electrodes 11 and 12. The connection island 33 is spaced apart from the first touch electrodes 11 and 12 and the second touch electrodes 21 and 22. One end of the first bridge 31 is electrically connected to the connection island 33, the other end is electrically connected to the first touch electrode 11. One end of the second bridge 32 is electrically connected to the connection island 33, the other end is electrically connected to the first touch electrode 12. The first touch electrodes 11 and 12 are electrically connected through the connection island 33, the first bridge 31 and the second bridge 32. The first bridge 31, the second bridge 32 and the third bridge 4 have a higher electrical conductivity than the first touch electrode 1 and the second touch electrode 2.

As shown in FIG. 2, the second connection pattern includes a third bridge 4. The third bridge 4 is insulated from the connection island 33. One end of the third bridge 4 is electrically connected to the second touch electrode 21, the other end is electrically connected to the second touch electrode 22. The second touch electrode 21 and the second touch electrode 22 are electrically connected through the third bridge 4.

Based on the above, adjacent first touch electrodes 11 and 12 along the first direction are electrically connected through the connection island 33, the first bridge 31 and the second bridge 32. The first touch electrode 11 is electrically connected to the connection island 33 through at least one first bridge 31, and the second touch electrode 12 is electrically connected to the connection island 33 through at least one second bridge 32. The resistance of the first bridge 31 and the second bridge 32 is far less than that of the first touch electrodes 11 and 12, thus a relatively small overall resistance of a column of first touch electrodes 1 can be achieved. Adjacent second touch electrodes 21 and 22 are electrically connected through the third bridge 4. The resistance of the third bridge 4 is far less than that of the second touch electrodes 21 and 22, thus a relatively small overall resistance of a row of second touch electrodes 2 can be achieved.

As compared to the conventional touch control display panels, a relatively small overall resistance of each column of first touch electrodes 1 and each row of second touch electrodes 2 can be achieved in the present touch control display panels, resulting in superior touch control function.

In some touch control display panels, to reduce the length of the third bridge 4, a width D1 of the connection island 33 along the second direction in a portion corresponding to the third bridge 4 is less than a maximum width D2 of the connection island 33 along the second direction.

Optionally, at least one second connection pattern includes a third bridge 4, and the third bridge 4 crosses the connection island 33 above its middle portion or one of its terminal portions.

As shown in FIG. 2, the second connection pattern includes a third bridge 4, and the third bridge 4 crosses the connection island 33 above its middle portion.

As shown in FIG. 3, the second connection pattern includes a third bridge 4, and the third bridge 4 crosses the connection island 33 above its terminal portion (e.g., the lower portion).

Optionally, the second connection pattern includes two third bridges 4, crossing the connection island 33 above two terminal portions (e.g., the upper portion and the low portion), respectively.

Typical human eyes are more sensitive to patterns arranged in horizontal or vertical direction than patterns arranged in other directions. To further improve display quality, the connection patterns in the present touch control display panels are optionally made less sensitive to typical human eyes. For example, the first bridge 21, the second bridge 32, and the third bridge 33 are arranged in directions other than horizontal and vertical direction (i.e., other than the first direction and the second direction).

Optionally, the first bridge extends along a direction at an acute angle relative to the first direction, and the second bridge extends along a direction at an acute angle relative to the first direction. Optionally, the third bridge includes a first segment and a second segment adjoining each other, the first segment extends along a direction at an acute angle relative to the first direction, and the second segment extends along a different direction at an acute angle relative to the first direction. Having a third bridge including multiple adjoining segments prevents shadowing effects in display caused by an elongated metal line extending along one direction.

Various embodiments may be practiced to arrange the touch electrodes relative to the bridges, e.g., to minimize the thickness of the display panel. In some embodiments, at each intersection, the first bridge 31, the second bridge 32, and the third bridge 4 are in a same layer, and are on a same side of the connection island 33 proximal to the base substrate 5. The display panel further includes an insulating layer insulating the first bridge 31, the second bridge 32 and the third bridge 4 from the connection island 33. The insulating layer includes a plurality of vias through which the first bridge 31 and the second bridge 32 at each intersection are electrically connected to the connection island 33 and the two adjacent first touch electrodes 11 and 12, and the third bridge 4 at each intersection are electrically connected to the two adjacent second touch electrodes 21 and 22. In some embodiments, at each intersection, the first bridge 31, the second bridge 32, and the third bridge 4 are in a same layer, and are on a same side of the connection island 33 distal to the base substrate 5. The display panel further includes an insulating layer insulating the first bridge 31, the second bridge 32 and the third bridge 4 from the connection island 33. The insulating layer includes a plurality of vias through which the first bridge 31 and the second bridge 32 at each intersection are electrically connected to the connection island 33 and the two adjacent first touch electrodes 11 and 12, and the third bridge 4 at each intersection are electrically connected to the two adjacent second touch electrodes 21 and 22.

Having the first bridge 31, the second bridge 32, and the third bridge 4 in a same layer further minimizes the thickness of the display panel.

Optionally, at least one of the first bridge 31, the second bridge 32 and the third bridge 4 is made of a metal.

In another aspect, the present disclosure provides a method of fabricating a touch control display panel. In some embodiments, the method includes forming a first touch electrode layer comprising a plurality of first touch electrodes; forming a second touch electrode layer comprising a plurality of second touch electrodes; forming a first connection pattern, and forming a second connection pattern. The plurality of first electrodes 1 are spaced apart along a first direction. The plurality of second electrodes 2 are spaced apart along a second direction. The first direction and the second direction are substantially perpendicular to each other. The second direction intersects the first direction forming a plurality of intersections.

At each intersection, the first connection pattern includes a connection island, at least one first bridge and at least one second bridge. The connection island is in a same layer as the first touch electrode layer. The connection island is spaced apart from the first touch electrodes and the second touch electrodes. One end of the first bridge is electrically connected to the connection island, the other end is electrically connected to the first touch electrode. One end of the second bridge is electrically connected to the connection island, the other end is electrically connected to another adjacent first touch electrode.

At each intersection, the second connection pattern includes a third bridge. The third bridge is insulated from the connection island. One end of the third bridge is electrically connected to the second touch electrode, the other end is electrically connected to another adjacent second touch electrode.

In some embodiments, the method includes forming a metal layer on the base substrate; patterning the metal layer to form the plurality of first bridges, the plurality of second bridges, and the plurality of third bridges; forming the insulating layer on a side of the plurality of first bridges, the plurality of second bridges, and the plurality of third bridges distal to the base substrate; forming the plurality of vias in the insulating layer; forming a transparent conductive layer on a side of the insulating layer distal to the base substrate; and patterning the transparent conductive layer to form the plurality of connection islands, the plurality of first touch electrodes, and the plurality of second touch electrodes.

In some embodiments, the method includes forming a transparent conductive layer on the base substrate; patterning the transparent conductive layer to form the plurality of connection islands, the plurality of first touch electrodes, and the plurality of second touch electrodes; forming the insulating layer on a side of the plurality of connection islands, the plurality of first touch electrodes, and the plurality of second touch electrodes distal to the base substrate; forming the plurality of vias in the insulating layer; forming a metal layer on a side of the insulating layer distal to the base substrate; and patterning the metal layer to form the plurality of first bridges, the plurality of second bridges, and the plurality of third bridges.

In another aspect, the present disclosure further provides a display device having a touch control display panel described herein or fabricated by a method described herein.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A touch control display panel, comprising:
a base substrate;
a first touch electrode layer comprising a plurality of first touch electrodes;
a second touch electrode layer comprising a plurality of second touch electrodes;
a plurality of connection islands;
a plurality of first bridges;
a plurality of second bridges; and
a plurality of third bridges;
wherein the plurality of first electrodes are spaced apart along a first direction; the plurality of second electrodes are spaced apart along a second direction; the second direction intersecting the first direction forming a plurality of intersections; a connection island is at each intersection surrounded by and insulated from two adjacent first touch electrodes along the first direction and two adjacent second touch electrodes along the second direction;
the connection island at each intersection is electrically connected to one of the two adjacent first touch electrodes through a first bridge and electrically connected to another of the two adjacent first touch electrodes through a second bridge; and
the two adjacent second touch electrodes are electrically connected at each intersection through a third bridge, the third bridge insulated from the connection island at each intersection.

2. The touch control display panel of claim 1, wherein the plurality of connection islands are in a same layer as the first touch electrode layer.

3. The touch control display panel of claim 1, wherein the first touch electrode layer is in a same layer as the second touch electrode layer.

4. The touch control display panel of claim 1, wherein the plurality of first bridges, the plurality of second bridges and the plurality of third bridges are in a same layer.

5. The touch control display panel of claim 1, wherein the first direction and the second direction are substantially perpendicular to each other.

6. The touch control display panel of claim 1, wherein any of the first bridge, the second bridge and the third bridge has a higher electrical conductivity than the first touch electrode and the second touch electrode.

7. The touch control display panel of claim 1, further comprising an insulating layer insulating the plurality of first bridges and the plurality of second bridges from the plurality of connection islands;
wherein the insulating layer comprises a plurality of vias through which the first bridge and the second bridge at each intersection are electrically connected to the connection island and the two adjacent first touch electrodes.

8. The touch control display panel of claim 1, further comprising an insulating layer insulating the plurality of third bridges from the plurality of connection islands;
wherein the insulating layer comprises a plurality of vias through which the third bridge at each intersection are electrically connected to the two adjacent second touch electrodes.

9. The touch control display panel of claim 1, further comprising an insulating layer insulating the plurality of first bridges, the plurality of second bridges and the plurality of third bridges from the plurality of connection islands;
wherein the insulating layer comprises a plurality of vias through which the first bridge and the second bridge at each intersection are electrically connected to the connection island and the two adjacent first touch electrodes, and the third bridge at each intersection are electrically connected to the two adjacent second touch electrodes.

10. The touch control display panel of claim 9, wherein the first bridge, the second bridge and the third bridge are on a side of the connection island proximal to the base substrate.

11. The touch control display panel of claim 9, wherein the first bridge, the second bridge and the third bridge are on a side of the connection island distal to the base substrate.

12. The touch control display panel of claim 1, wherein a width of the connection island along the second direction in a portion corresponding to the third bridge is less than a maximum width of the connection island along the second direction.

13. The touch control display panel of claim 1, wherein at least one pair of two adjacent second touch electrodes are electrically connected at each intersection through only one third bridge.

14. The touch control display panel of claim 12, wherein at least one pair of two adjacent second touch electrodes are electrically connected at each intersection through two third bridges, projections of which on the connection island are proximal to two terminus of the connection island along the first direction.

15. The touch control display panel of claim 1, wherein the first bridge extends along a direction at an acute angle relative to the first direction, and the second bridge extends along a direction at an acute angle relative to the first direction.

16. The touch control display panel of claim 1, wherein the third bridge comprises a first segment and a second segment adjoining each other, the first segment extends along a direction at an acute angle relative to the first direction, and the second segment extends along a direction at an acute angle relative to the first direction.

17. (canceled)

18. A display device comprising the touch control display panel of claim 1.

19. A method of fabricating a touch control display panel, comprising:
forming a first touch electrode layer comprising a plurality of first touch electrodes;
forming a second touch electrode layer comprising a plurality of second touch electrodes;
forming a plurality of connection islands;
forming a plurality of first bridges;
forming a plurality of second bridges; and
forming a plurality of third bridges;
wherein the plurality of first electrodes are spaced apart along a first direction; the plurality of second electrodes are spaced apart along a second direction; the second direction intersecting the first direction forming a plurality of intersections; a connection island is at each intersection surrounded by and insulated from two adjacent first touch electrodes along the first direction and two adjacent second touch electrodes along the second direction;
the connection island at each intersection is electrically connected to one of the two adjacent first touch electrodes through a first bridge and electrically connected to another of the two adjacent first touch electrodes through a second bridge; and
the two adjacent second touch electrodes are electrically connected at each intersection through a third bridge, the third bridge insulated from the connection island at each intersection.

20. The method of claim 19, further comprising:
forming an insulating layer; wherein the insulating layer insulates one or more of the plurality of first bridges, the plurality of second bridges, and the plurality of third bridges from the plurality of connection islands; and
forming a plurality of vias through which the first bridge and the second bridge at each intersection are electrically connected to the connection island and the two adjacent first touch electrodes, and the third bridge at each intersection are electrically connected to the two adjacent second touch electrodes.

21. (canceled)

22. The method of claim 20, further comprising:
forming a transparent conductive layer on a base substrate;
patterning the transparent conductive layer to form the plurality of connection islands, the plurality of first touch electrodes, and the plurality of second touch electrodes;
forming the insulating layer on a side of the plurality of connection islands, the plurality of first touch electrodes, and the plurality of second touch electrodes distal to the base substrate;
forming the plurality of vias in the insulating layer;
forming a metal layer on a side of the insulating layer distal to the base substrate; and
patterning the metal layer to form the plurality of first bridges, the plurality of second bridges, and the plurality of third bridges.
